(19) United States
(12) Patent Application Publication
(10) Pub. No.: US 2004/0185684 A1
(43) Pub. Date: Sep. 23, 2004

(54) Attachment system for the mechanical and electrical connection of a carrier system to a motor vehicle

(75) Inventors: Martin Lindstrom, Gothenburg (SE); Volker Stein, Wiesbaden (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignees: Adam Opel AG; Lear Corporation GmbH & Co. KG

(21) Appl. No.: 10/738,612

(22) Filed: Dec. 17, 2003

(30) Foreign Application Priority Data
Dec. 19, 2002 (DE) 102 60 506.8

(51) Int. Cl. H01R 33/00

(52) U.S. Cl. 439/34

(57) ABSTRACT

The object of this invention relates to an attachment system (1) for the releasable connection of a carrier system for supplementary equipment to a motor vehicle, comprising at least: a first subsystem (2) arranged in a first housing (4) with a connection mechanism (5) and a second subsystem (3), which interacts, corresponds and can be connected to the first subsystem (2), having a connection device (6), whereby the first subsystem (2) is arranged on the attachment system and the second subsystem (3) is arranged on the motor vehicle, whereby the connection mechanism (5) exhibits at least one mechanical latching device (10), a lever mechanism (7) and an electrical/electronic contacting device (11), whereby the latching device (10) and the electrical/electronic contacting device (11) are coupled together by means of the lever mechanism (7) and the second subsystem (3) comprises a connection device (6), corresponding to the connection mechanism (5), for engaging the connection mechanism (5), so that on actuation of the lever mechanism (7) a mechanically heavy duty connection, which is secure in a crash and also forms an electrical/electronic connection of the two subsystems (2, 3), can be realised.

The invention relates to an attachment system for releasably connecting a carrier system for supplementary equipment to a motor vehicle, comprising at least: a first subsystem arranged in a first housing with a connection mechanism and a second subsystem, which interacts with, corresponds and connects to the first subsystem, having a connection device, whereby the first subsystem is arranged on the carrier system and the second subsytem is arranged on the motor vehicle.

These types of attachment systems are used normally in the automotive field, in particular for the installation of modules or modular structured assemblies into a basic model for retrofitting, or for new installations. Such attachment systems are primarily used in the car industry with its structure of subcontractors for easy and time-saving installation or modification, or also retrofitting.

From DE 200 17 905 U1 a plug-in connector for the connection and test of two connector parts is known. This plug-in connector exhibits a stationary connecting part which can be installed, a contact piece axially guided on it, which is electrically connected to the connecting part in a test position and a plug part, which can be moved relatively in the same direction to the contact piece, which contacts the connecting part in the functional position, but which is contact free in the test position.

A disadvantage of this solution is the relatively large installation space. In addition, the plug-in connector is essentially only intended for making an electrical contact and is not suitable for establishing a mechanical connection.

Furthermore, a press-on connector for an electrical system is known from DE 195 48 561 A1, especially for motor vehicle combination instruments. With this solution an electrical contact arranged in a first plug part can be releasably connected by means of an actuation device to a counter-contact mounted in a second plug part. In order, for example, to mount display devices more simply and in a cost-saving manner on a dashboard and to also facilitate the establishment of a secure electrical contact, in this solution the electrical contact is connected to the electrical counter-contact by a linear movement of the actuating device within the first plug part exhibiting the electrical contact, the said plug part being mounted on a circuit board, whereby the second plug part is permanently connected to a carrier element and during the contacting of the contact and counter-contact simultaneously the first plug part can be latched to the carrier element by means of a locking device of the actuation device, the said locking device protruding above the first plug part in the direction of movement.

A disadvantage of this solution is that the locking device protrudes over the first plug part and consequently installation space is taken up unnecessarily. In addition, the connector is essentially only rated for electrical/electronic contacting, but not at all for the realisation of a high-strength mechanical connection.

Also known are various sorts of car supplementary equipment which are connected to the on-board electronics/electrical system of the motor vehicle, such as for example cooler boxes, which can be placed loosely in the foot space at the rear of a motor vehicle or are arranged between the rear seat and the backrest of a front seat.

With these types of supplementary equipment it is a disadvantage that with a crash this supplementary equipment is catapulted like a cannon ball through the interior of the vehicle, whereby a substantial risk of injury exists for the vehicle occupants.

It is therefore the object of this invention to provide an attachment system with which the installation space available in a motor vehicle is optimally exploited and a high-strength mechanical connection, which is simple to handle, can be established with an electrical/electronic connection.

This object is solved based on an attachment system according to the generic term of claim 1 in conjunction with its characteristic features. Advantageous developments of the invention are given in the dependent claims.

The invention includes the technical art in that the connection mechanism exhibits at least one mechanical latching device, a lever mechanism and an electrical/electronic contacting device, whereby the latching device and the electrical/electronic contacting device are coupled together by means of the lever mechanism and the second subsystem comprises a connection device corresponding to the connection mechanism for engaging the connection mechanism, so that with the actuation of the lever mechanism a mechanically heavy duty connection, which is secure in a crash and simultaneously provides an electrical/electronic connection of both subsystems, can be realised.

This solution offers the advantage that a mechanical connection and also electrical/electronic contacting can be made with one grasp of the hand in an ergonomic and simple manner. Due to the functionally integrating arrangement, in addition a compact attachment system can be realised which requires an optimised installation space. The invention is in this respect not restricted to carrier systems or motor vehicles. Moreover, the invention is generally suitable for the connection of connecting parts. A connecting part for the purposes of the invention may be a motor vehicle, more precisely the bottom section of a motor vehicle, or also a tunnel system of a motor vehicle. For the purposes of the invention, a tunnel system is taken to mean a tunnel and its development and also the electrical/electronic system running in the tunnel. Since the attachment system is subdivided into two parts, almost all possible connections can be exploited. Here, the connection mechanism of a first subsystem exhibits means of engagement, which engage in a connection device of a second subsystem. In this manner the attachment system can be extended as required in that a second attachment system can be coupled to the first attachment system. In this way, several attachment systems can be coupled together.

It is advantageous that the connection mechanism exhibits a latching device, which in the unconnected state does not protrude beyond the housing of the first subsystem. The latching device is then well protected from external influences. In addition, the connection mechanism then exhibits fewer protruding components which are relevant to safety, which may be easily and unnoticeably damaged due to an exposed position.

Another measure, which improves the invention, is that the housing exhibits at least one outer plastic cover for protection and at least one inner steel reinforcement for the reliable accommodation of extraordinary forces, in particular forces occurring during a crash. An external plastic cover has the advantage that it can be optimally matched to the attachment system with regard to the visual appearance and installation volume. For the accommodation of higher forces the housing exhibits at least one inner steel reinforcement. This is covered by the outer plastic cover, so that the risk of injury to the occupants is reduced. Due to this plastic/steel combination, the advantages of both materials can be optimally exploited, whereby the disadvantages are in each case compensated by the other material.

A preferred embodiment provides for the steel reinforcement exhibiting a first region which is formed for the connection of the attachment system to a first connecting part. Due to the arrangement of a connection region on the steel reinforcement a secure and reliable attachment to a connecting part is then realised. A possible connecting part for the application of an attachment system according to the invention is for example a carrier system for the attachment of supplementary interior equipment in a motor vehicle.

In an advantageous manner the first region of the steel reinforcement exhibits openings for releasable connection and side areas matched to the first connecting part and formed as abutments. Through the integration of supporting and reinforcing functions and support in the steel reinforcement a smaller construction can be realised due to this functional integration.

Here the releasable connections are preferably formed by bolted or screwed joints for standardised and simple, releasable connections.

Furthermore, it is advantageous that the steel reinforcement exhibits a second region which is formed for the swivelling support of the latching device. In this way further functional integration is realised, whereby an overall smaller construction of the attachment system is possible.

According to the invention the second region is formed such that the second region exhibits through openings and abutment areas for supporting a latching device complete with restoring element.

A further advantage is obtained in that the second region exhibits a groove for the accommodation of a corresponding connection device. In this way an even more reliable connection between the first and second subsystems is obtained, because in this way not only the means of engagement of the connection mechanism, but also the groove of the steel reinforcement interact with the second subsystem.

It is especially advantageous that the mechanical latching device is formed as a hook, swivelling about an axis and with a restoring element, and which can be swivelled into a latching position by means of the lever mechanism. Due to the latching device swivelling about an axis, a space-saving, reliable connection is possible.

It is also advantageous in this respect that the restoring element is formed as a return spring in order to facilitate the construction of a small latching device.

A measure which improves the invention provides for the contacting devices to comprise at least one plug holder, a plug and a cable system, whereby the plug is coupled to the lever mechanism by means of the plug holder. In this way a variable design and routing of an electrical/electronic connection can be realised. Due to the cable system and the preferably two corresponding plugs, a connection can be arranged almost anywhere on the attachment system. The plug holder also enables various plug types to be used, because the plug holder is formed as an interface between the attachment system and the plug.

It is advantageous that the plug holder on being actuated by the lever mechanism is guided such that it executes a translation movement. This means that a reliable and simply implemented guidance is ensured which guarantees a reliable plug connection and therefore secure electrical/electronic contacting.

A special advantage is that the contacting device exhibits a plug and a socket which are connected together by means of the cable system, whereby the plug is formed as an interface to the second connecting part and the socket is formed as interface to the first connecting part. Therefore, the connecting parts can be used both with and without the attachment system, which means that an expensive and complicated retrofit of existing connecting parts can be omitted.

The attachment system is advantageously designed such that the connection device comprises a mechanical latching contrivance, an electrical/electronic plug device and a housing which can be closed with a lid, whereby the mechanical latching contrivance and the electrical/electronic plug device are formed corresponding to the mechanical latching device and the electrical/electronic contacting device of the connection mechanism. Due to this design, the connection device can be accommodated as an associated unit separately on a connecting part. In particular, the connection device can be arranged recessed in the connecting part to such an extent that the closed lid essentially closes flush with the surface of the connecting part. When using the connecting device, the lid can be opened, whereby the interface is accessible and on releasing the connection the lid is closed, whereby the interface is protected.

An advantage of the invention can be achieved in that the mechanical latching contrivance is formed as a panel with at least one lug. This lug thus forms the engaging method for the hook of the latching device. This type of latching contrivance can be easily produced, whereby high forces can also be taken up and the whole latching device can be easily arranged on connecting parts, such as for example on the body of a motor vehicle.

Preferably the electrical/electronic plug device is connected to the on-board electrical supply/on-board electronics running through the tunnel and therefore formed as an electrical/electronic interface between the tunnel system and the attachment system.

Also preferred, the mechanical latching contrivance and the electrical/electronic plug device are arranged essentially in the cavities of the housing, whereby they do not protrude in the direction of the vehicle interior, so that they can be covered by means of the lid. In this manner, a possible risk of injury to the occupants can be further reduced.

A further preferred design of the attachment system provides for the housing with the lid closed is flush with the side of the tunnel system facing the vehicle interior.

Further measures improving the invention are given in the sub-claims or are explained in more detail in the following together with the description of a number of preferred embodiments of the invention by means of the figures. The following are shown:

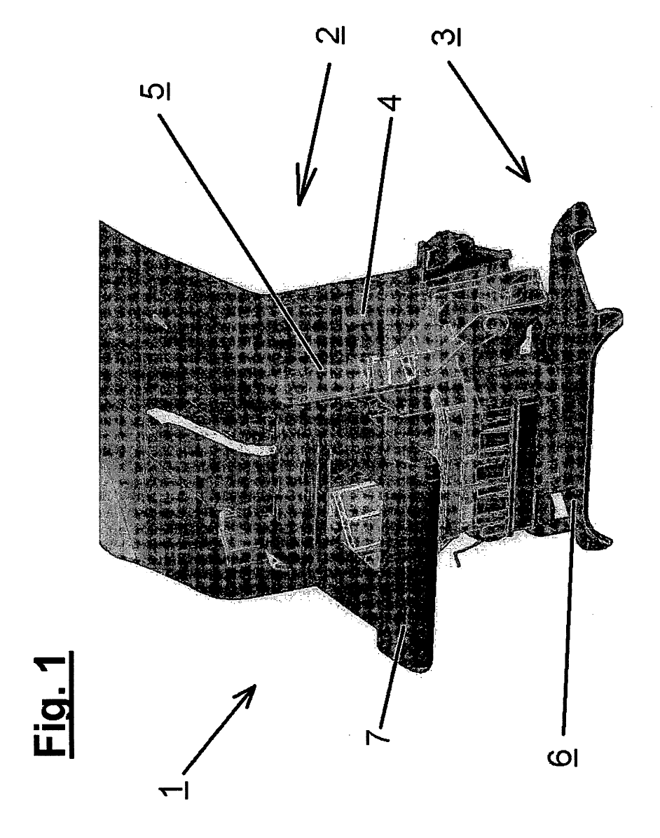

FIG. 1 a perspective view of an attachment system according to the invention,

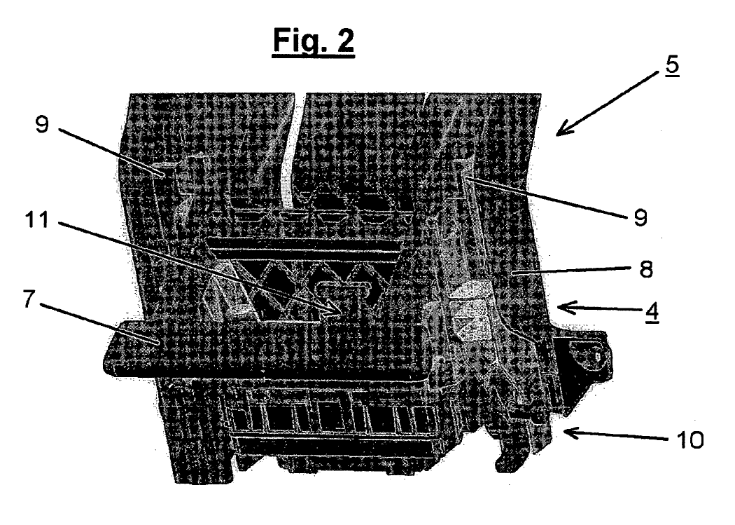

FIG. 2 a perspective view of a first subsystem of the attachment system according to the invention in FIG. 1,

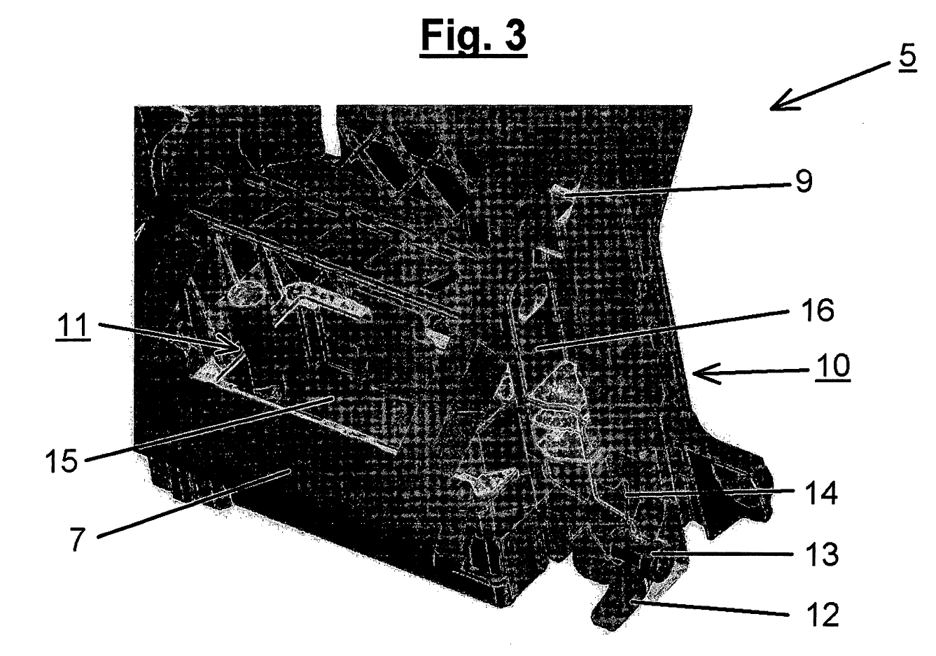

FIG. 3 an extract of the first subsystem illustrated in FIG. 2 in another perspective view,

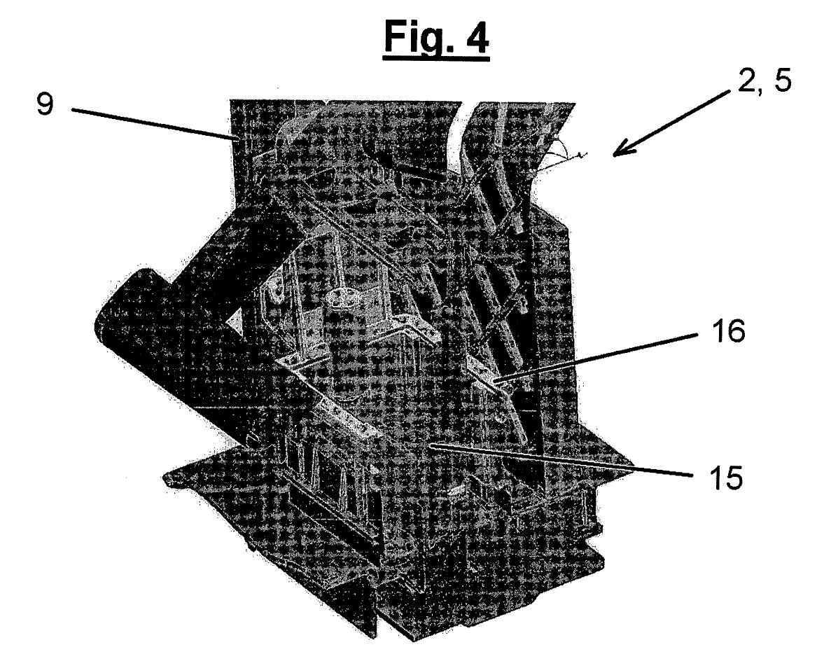

FIG. 4 a section through the first subsystem illustrated in FIG. 2 as a perspective view,

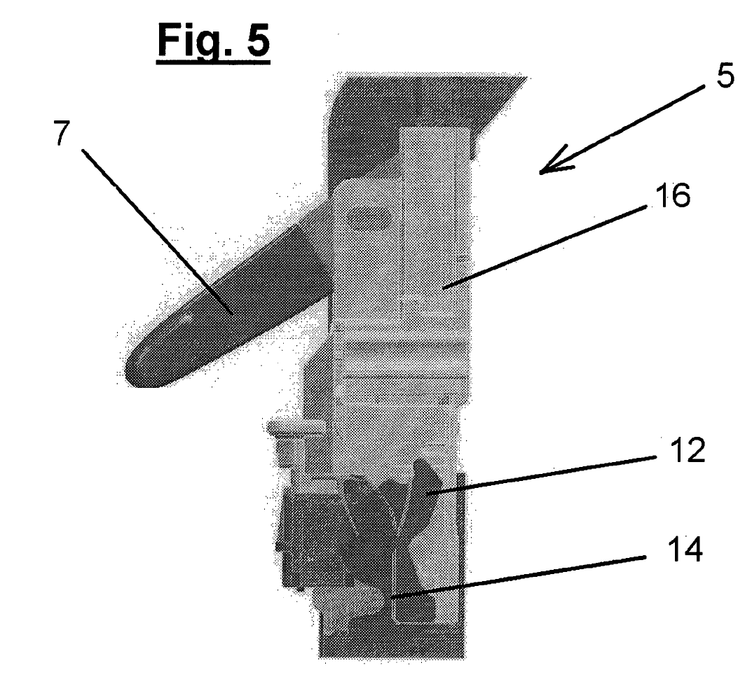

FIG. 5 a 3D side elevation of a connection mechanism according to the invention,

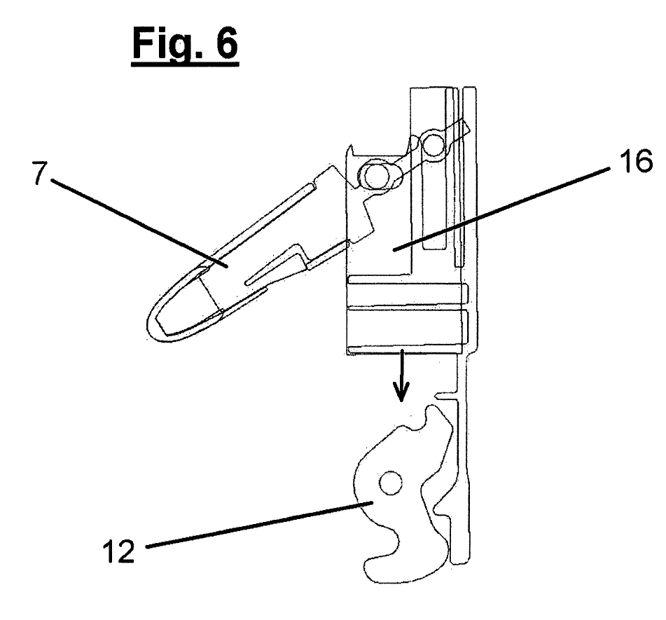

FIG. 6 a schematic side elevation of a connection mechanism according to the invention and

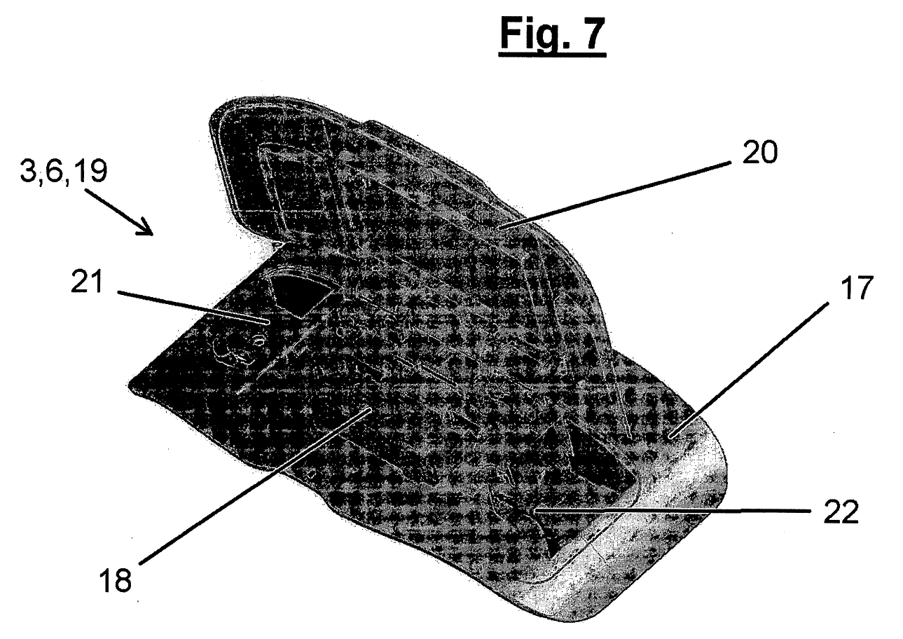

FIG. 7 a 3D side elevation of a connection mechanism according to the invention.

FIG. 1 shows an attachment system 1 in a perspective representation. The attachment system 1 exhibits a first subsystem 1 and a second subsystem 3. The first subsystem 2 exhibits a connection mechanism 5, arranged in a housing 4, for connection to the second subsystem 3. The second subsystem 3 exhibits a connection device 6 corresponding to the connection mechanism 5 of the first subsystem 2. Furthermore, in the first subsystem a lever mechanism 7 is arranged with a lever by means of which the attachment system 1 can be actuated, so that the two subsystems 2, 3 act together and realise a mechanically heavy duty connection, which is secure in a crash.

The perspective view in FIG. 2 of the first subsystem 2 of the attachment system clearly shows the construction of the housing 4 and the connection mechanism 5. The housing 4 exhibits an upper plastic cover 8 and a steel reinforcement 9 arranged beneath it. The steel reinforcement 9 is here constructed as a profile in two parts, which border the attachment system to the side with the plastic cover 8. The two profiles are arranged as symmetrical mirror images of one another. The connection mechanism 5 according to FIG. 2 comprises a latching device 10, which is arranged on the steel reinforcement 9 and can be actuated by means of a lever mechanism 7 coupled to the latching device 10. Furthermore, the connection mechanism 5 comprises a contacting device 11, which can also be actuated by means of the lever mechanism 7.

FIG. 3 illustrates an extract from the first subsystem, in particular the steel reinforcement 9, the connection mechanism 5 with the latching device 10 and the contacting device 11 from another viewing angle. The latching device 10 comprises a hook 12, which can be swivelled via a bolt 13 and is arranged on the steel reinforcement 9 coupled to the lever mechanism 7. The steel reinforcement 9 exhibits for this purpose a region which is formed for the accommodation of the latching device 10 and in particular exhibits a through opening for the accommodation of the bolt 13 for realising a bolt connection. The latching device 10 exhibits a restoring element 14 coupled to the hook 12, the said restoring element being formed as a return spring. Furthermore, the steel reinforcement 9 exhibits in this region a groove, open to the end of the steel reinforcement 9, in which a connection device of a second subsystem can engage and the side of which, open towards the outside, is enclosed on actuation of the lever mechanism 7 by the hook 12, so that an interlocking connection can be realised. The contacting device 11 comprises a plug 15, a plug holder 16 and a cable system (not illustrated). The plug 15 is arranged on the plug holder 16. The plug holder 16 exhibits a region with an elongated hole. This elongated hole is the coupling point of the plug holder 16 with the lever mechanism 7, whereby the elongated hole acts as a receptacle and as a support for a formed shape of the lever mechanism 7. On actuation of the lever mechanism 7, the swivel movement of the lever mechanism is transformed partly by means of this elongated hole into an essentially translational movement of the plug holder 16. For realising the translational movement of the plug holder 16, it is additionally guided by means of the steel reinforcement 11. Here, the steel reinforcement 11 is formed such that at least one part of the plug holder can slide like a type of slide block in the specially formed profile of the steel reinforcement 11. On actuation of the lever mechanism 7, this part of the plug holder 16 acting as a slide block simultaneously triggers the swivel movement of the hook 12 so that simultaneously a translational movement—that of the plug holder 16 with the plug 15—and a rotational movement—that of the hook 12—are implemented.

Based on the section through the first subsystem of an attachment system according to the invention shown in FIG. 4, in particular through the connection mechanism 5, the construction of the attachment system is clarified further. In particular the formation of the plug holder 16 and the arrangement of the plug 15 in the plug holder 16 are clearly shown. Apart from a frame accommodating the plug 15, the plug holder 16 exhibits a region formed like a type of slide block, which is movable linearly within the steel reinforcement profile. Alternatively, the plug can also directly exhibit a region which is formed like a type of slide block. In this way a component can be saved. The two-part design of the plug 15 and the plug holder 16 however offer the advantage that different types of plug can be arranged on the plug holder 16, so that a higher compatibility with as many types of plug as possible can be achieved. From the illustration it will also be apparent that a large part of the components are manufactured from plastic, in order to save weight in this way. Only the steel reinforcements as load-bearing parts are made from non-plastic materials.

In FIG. 5 a 3D side elevation of the connection mechanism 5 is illustrated. From this illustration the kinematics of the connection mechanism can be clearly seen. On actuating/swivelling the lever mechanism 7 the movement is transferred to the plug holder 16, which executes a translational movement due to the guidance. At the same time, projections formed in the plug holder 16 press on the hook 12 which is arranged for swivel movement and which executes a rotational movement in parallel to the translational movement of the plug holder 16. Due to the swivel movement, the hook 12 encloses an appropriately formed connection device for the mechanical connection of a first and a second subsystem. The restoring element 14 is stressed during the actuation and thus supports the opposing actuation.

The connection mechanism is shown schematically in FIG. 6. In this schematic diagram the kinematic chain consisting of the lever mechanism 7, the plug holder 16 and the hook 12 are clearly shown.

Finally, FIG. 7 shows the second subsystem with the connection device 6 in a perspective view. The connection device 6 comprises a socket 18, which is arranged in a second housing 17 and corresponds to the plug on the connection mechanism, a latching contrivance 19 and a lid 20 for closing the second housing 17. The latching contrivance 19 exhibits lugs 22 arranged on a panel 21, which fit into the groove of the steel reinforcement of the latching device and can be enclosed by the hook of the latching device. The latching contrivance 19 can be connected by means of the panel to a connecting part, for example to a motor vehicle.

1. Attachment system (1) for the releasable connection of a carrier system for supplementary equipment to a motor vehicle, comprising at least: a first subsystem (2), arranged in a first housing (4), with a connection mechanism (5) and a second subsystem (3), which interacts, corresponds and can be connected to the first subsystem (2), with a connection device (6), whereby the first subsystem (2) is arranged on the carrier system and the second subsystem (3) is arranged on the motor vehicle, characterised in that the connection mechanism (5) exhibits at least one mechanical latching device (10), a lever mechanism (7) and an electrical/electronic contacting device (11), whereby the latching device (10) and the electrical/electronic contacting device (11) are coupled to one another by means of the lever mechanism 7 and the second subsystem (3) comprises a connection device (6) corresponding to the connection mechanism (5) for engaging the connection mechanism (5), so that on actuation of the lever mechanism (7) a mechanically heavy duty connection, which is secure in a crash and simultaneously an electrical/electronic connection of the two subsystems (2, 3) can be realised.

2. Attachment system (1) according to claim 1, characterised in that the latching device (10) of the connection mechanism (5) is arranged in the unconnected state within the first housing (4) of the first subsystem (2).

3. Attachment system (1) according to claim 1 or 2, characterised in that the first housing (4) exhibits at least one outer plastic cover (8) for protection and at least one inner steel reinforcement (9) for taking up forces, in particular forces occurring during a crash.

4. Attachment system (1) according to claim 3, characterised in that the steel reinforcement (9) exhibits a first region which is formed for the connection of the attachment system (1) to the carrier system.

5. Attachment system (1) according to claim 3 or 4, characterised in that the first region of the steel reinforcement (9) exhibits openings for the releasable connection as well as side areas adapted to the carrier system and formed as abutments.

6. Attachment system (1) according to one of the previous claims 3 to 5, characterised in that the releasable connections are preferably formed as bolted or screwed joints.

7. Attachment system (1) according to claim 3, characterised in that the steel reinforcement (9) exhibits a second region, which is formed for the swivelling support of the latching device (10).

8. Attachment system (1) according to claim 7, characterised in that the second region exhibits through openings as well as abutment surfaces for the support of the latching device (10) complete with restoring element (14).

9. Attachment system (1) according to claim 7 or 8, characterised in that the second region of the steel reinforcement (9) exhibits a groove for the accommodation of the corresponding connection device (6).

10. Attachment system (1) according to one of the previous claims, characterised in that the mechanical latching device (10) is formed as a hook (12), which can swivel about an axis, with a return spring (14), and which can swivel by means of the lever mechanism (7) into an interlocking position.

11. Attachment system (1) according to one of the previous claims, characterised in that the contacting devices (11) comprise at least
a plug holder (16),
a plug (15), and
a cable system, whereby the plug (15) is coupled by means of the plug holder (16) to the lever mechanism.

12. Attachment system (1) according to claim 11, characterised in that the plug holder (16) on actuation by means of the lever mechanism (7) is guided such that a translational movement is executed.

13. Attachment system (1) according to claim 11 or 12, characterised in that the contacting device (11) exhibits a plug (15) and a socket (18) which are connected together by means of the cable system, whereby the plug (15) is formed as an interface to a motor vehicle and the socket (18) is formed as an interface to the carrier system.

14. Attachment system (1) according to one of the previous claims, characterised in that the connection device (6) comprises
a mechanical latching contrivance (19),
an electrical/electronic plug device, and
a second housing (17) which can be closed off with a lid (20), whereby the mechanical latching contrivance (19) and the electrical/electronic plug device are formed corresponding to the mechanical latching device (10) and the electrical/electronic contacting device (11) of the connection mechanism (5).

15. Attachment system (1) according to claim 14, characterised in that the mechanical latching contrivance (19) is formed as a panel (21) with at least one lug (22).

16. Attachment system (1) according to claim 14 or 15, characterised in that the electrical/electronic plug device can be connected to the on-board electrical system/on-board electronics running through a tunnel, thus forming an electrical/electronic interface between the tunnel system and the attachment system (1).

17. Attachment system (1) according to one of the claims 14 to 16, characterised in that the mechanical latching contrivance (19) and the electrical/electronic plug device are essentially arranged in the cavities of the second housing (17) and do not protrude beyond it in the direction of the vehicle interior, so that they can be covered by means of the lid (20).

18. Attachment system (1) according to one of the previous claims, characterised in that the second housing (17) with the lid (20) closed is flush with the side of the tunnel system facing the vehicle interior.
